(19) United States
(12) Patent Application Publication
(10) Pub. No.: US 2016/0035045 A1
(43) Pub. Date: Feb. 4, 2016

(54) IDENTIFYING OCCUPATION OF A PROFESSIONAL USING PROFILE AND SOCIAL DATA

(71) Applicant: Linkedln Corporation, Mountain View, CA (US)

(72) Inventors: Chen Chang, San Jose, CA (US); Wenjin Zhang, Menlo Park, CA (US); Marie Kim, San Mateo, CA (US); Junghoon Andrew Ahn, Cupertino, CA (US)

(21) Appl. No.: 14/473,558

(22) Filed: Aug. 29, 2014

Related U.S. Application Data
(60) Provisional application No. 62/031,725, filed on Jul. 31, 2014.

(51) Int. Cl. G06Q 50/00; G06Q 10/10

(52) U.S. Cl. CPC G06Q 50/01; G06Q 10/105

(57) ABSTRACT

Systems and methods are disclosed that determines an occupation for a member of a social networking site based on information obtained from a profile of that member. The obtained information may include employment information, such as a job title, skills that the member has identified as possessing, endorsements by other members of the identified skills, and information about the endorsers of the endorsements. The disclosed systems and methods may determine one or more probabilities for various occupations that the member may have, and may further adjust those probabilities based on the obtained information. The systems and methods may additionally provide a list of members that have a given occupation based on the corresponding occupation probability of the given occupation. The systems and methods may also provide a list of organizations (i.e., employers) where it was determined that it was unlikely that the organization has any members with the given occupation.

### CROSS-REFERENCE TO RELATED APPLICATIONS

This application claims the benefit of priority to U.S. Prov. Pat. App. No. 62/031,725, titled “Identifying Occupation Of A Professional Using Profile and Social Data,” filed Jul. 31, 2014, the disclosure of which is incorporated by reference herein.

### TECHNICAL FIELD

The subject matter disclosed herein generally relates to a system and method for determining a user's occupation, and, in particular, to determining a user's occupation based on his or her profile and/or social data.

### BACKGROUND

A social networking site may have one or more members. A member of the social networking site may have a profile detailing information about him or her. Information included in the member's profile may include employment or other job-related information. A user accessing the social networking site may desire to find a member having a particular occupation or position within a company (e.g., a salesperson). However, not every member of the social networking site may identify his or her occupation and/or position. Alternatively, the member may perform job function that are similar to the functions performed by the particular occupation or position, but the member may list a job title on his or her profile that is different from the occupation or position being searched. In these instances, the user may pass over members of the social networking site even though those members may have the requisite occupation or position for which the user is searching.

### BRIEF DESCRIPTION OF THE DRAWINGS

Some embodiments are illustrated by way of example and not limitation in the figures of the accompanying drawings.

FIG. 1 is a block diagram of a system in accordance with an example embodiment, including user devices and a social networking server.

FIG. 2 is a block diagram illustrating various components of a social networking server in accordance with an example embodiment.

FIG. 3 illustrates a first member profile, in accordance with an example embodiment, having information that may be processed by the social networking server of FIG. 1 to determine a member's occupation.

FIG. 4 illustrates a second member profile, in accordance with an example embodiment, having information that may be processed by the social networking server of FIG. 1 to determine a member's occupation.

FIG. 5 illustrates a process, in accordance with an example embodiment, of the social networking server of FIG. 1 segmenting member profile groups.

FIG. 6 illustrates a process, in accordance with an example embodiment, of the social networking server of FIG. 1 further segmenting member profile groups based on skills and endorsements.

FIG. 7 illustrates a method, in accordance with an example embodiment, for determining a member's occupation.

FIG. 8 is a block diagram illustrating components of a machine, in accordance with an example embodiment, configured to read instructions from a machine-readable medium.

### DETAILED DESCRIPTION

Example methods and systems are directed to determining an occupation for a member of a social network site based on information from the member's profile and other social data. The member's profile may be divided into one or more sections, and the member's occupation may be probabilistically determined based on the information contained in those sections. The sections may include a summary section (e.g., a “headline”), a skills section having one or more skills (e.g., skills or attributes that the member has identified as possessing), and one or more endorsements of those skills (e.g., indications from one or more other members that the member possesses the listed skill or attribute). The disclosed systems and methods may leverage one or more of these sections to determine an occupation of the member, even if that member does not explicitly identify himself or herself as having that occupation.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one embodiment, this disclosure provides for a method for determining an occupation of a person employed at a company. The method may include identifying, with one or more processors, a second plurality of company profiles from a first plurality of company profiles based on an occupation threshold, the occupation threshold corresponding to a predetermined amount of member profiles where a member profile has been identified as having a specified occupation and identifying, with the one or more processors, a third plurality of company profiles from the first plurality of company profiles based on the identified second plurality of company profiles, the third plurality of company profiles having at least one company profile associated with a member profile where the specified occupation is not assigned. The method may also include, for at least one company profile within the third plurality of company profiles, assigning, with the one or more processors, the specified occupation to an associated member profile based on one or more attributes selected by a member corresponding to the member profile. The method may further include assigning the member profile to a plurality of member profiles having the specified occupation.

In another embodiment of the method, one or more attributes may include at least one skill that the member has identified as possessing, the at least one skill having been selected from a plurality of selectable skills.

In a further embodiment of the method, at least one attribute of the one or more attributes may have an endorsement value, the endorsement value indicating whether one or more other members have endorsed the member as having the at least one attribute.

In yet another embodiment of the method, the one or more attributes may include at least one skill that the member has selected from a plurality of skills and the at least one skill may have an endorsement value, the endorsement value indicating whether one or more other members have endorsed the member for the at least one skill. The method may also include assigning the specified occupation to the associated member profile comprises evaluating the endorsement value of the at least one skill.

In yet a further embodiment of the method, an occupation assigned to the one or more other members may affect the endorsement value of the at least one skill.

In another embodiment of the method, each of the one or more other members may have an associated endorsement value, and the associated endorsement value may be affected based on an occupation assigned to the corresponding one or more other members.

In a further embodiment of the method, the associated endorsement value of one or more of the other members may be assigned a first value when the one or more of the other members is assigned an occupation that corresponds to the specified occupation and the associated endorsement value of one or more of the other members may be assigned a second value when the one or more of the other members is assigned an occupation that does not correspond to the specified occupation, wherein the first value is greater than the second value.

In yet another embodiment of the method, a plurality of attributes may be mapped to a plurality of occupations; and the method may further include selecting the specified occupation from the plurality of occupations based on a comparison of the one or more attributes selected by the member.

This disclosure further provides for a system that may include a non-transitory, computer-readable medium that stores computer-executable instructions, and one or more processors in communication with the non-transitory, computer-readable medium that, when the computer-executable instructions are executed, may be configured to analyze a first plurality of member profiles of a social network to determine whether any of the member profiles have been identified as having a specified occupation and assign at least one member profile from the first plurality of member profiles to a second plurality of member profiles when the at least one member profile has not been identified as having the specified occupation. The one or more processors may be further configured to determine whether to associate the specified occupation with the at least one member profile of the second plurality of member profiles based on one or more attributes associated with the at least one member profile, the one or more attributes having been selected by a member corresponding to the at least one member profile, and associate the specified occupation with the at least one member profile based on an affirmative determination.

In another embodiment of the system, the one or more attributes may include at least one skill that the member has identified as possessing, the at least one skill having been selected from a plurality of selectable skills.

In a further embodiment of the system, at least one attribute of the one or more attributes may have an endorsement value, the endorsement value indicating whether one or more other members have endorsed the member as having the at least one attribute.

In yet another embodiment of the system, one or more attributes may include at least one skill that the member has selected from a plurality of skills, and the at least one skill may have an endorsement value, the endorsement value indicating whether one or more other members have endorsed the member for the at least one skill. In addition, the one or more processors may be further configured to determine whether to associate the specified occupation with the at least one member profile of the second plurality of member profiles by evaluating the endorsement value of the at least one skill.

In yet a further embodiment of the system, an occupation may be assigned to the one or more other members which affects the endorsement value of the at least one skill.

In another embodiment of the system, each of the one or more other members may have an associated endorsement value, and the associated endorsement value is affected based on an occupation assigned to the corresponding one or more other members.

In a further embodiment of the system, the associated endorsement value of one or more of the other members may be assigned a first value when the one or more of the other members is assigned an occupation that corresponds to the specified occupation, the associated endorsement value of one or more of the other members may be assigned a second value when the one or more of the other members is assigned an occupation that does not correspond to the specified occupation, and the first value may be greater than the second value.

In yet another embodiment of the system, a plurality of attributes may be mapped to a plurality of occupations, and the one or more processors are further configured to select the specified occupation from the plurality of occupations based on a comparison of the one or more attributes selected by the member.

This disclosure additionally provides for a non-transitory, computer-readable medium having computer-executable instructions stored thereon that, when executed by one or more processors, cause the one or more processors to perform a method. In one embodiment, the method may include identifying, with one or more processors, a second plurality of company profiles from a first plurality of company profiles based on an occupation threshold, the occupation threshold corresponding to a predetermined amount of member profiles where a member profile has been identified as having a specified occupation, and identifying, with the one or more processors, a third plurality of company profiles from the first plurality of company profiles based on the identified second plurality of company profiles, the third plurality of company profiles having at least one company profile associated with a member profile where the specified occupation is not assigned. The method may also include for at least one company profile within the third plurality of company profiles, assigning, with the one or more processors, the specified occupation to an associated member profile based on one or more attributes selected by a member corresponding to the member profile. The method may further include assigning the member profile to a plurality of member profiles having the specified occupation.

In another embodiment of the non-transitory, computer-readable medium of claim, the one or more attributes may include at least one skill that the member has selected from a plurality of skills, the at least one skill may have an endorsement value, the endorsement value indicating whether one or more other members have endorsed the member for the at least one skill, and assigning the specified occupation to the associated member profile may include evaluating the endorsement value of the at least one skill.

In a further embodiment of the non-transitory, computer-readable medium, each of the one or more other members may have an associated endorsement value, and the associated endorsement value may be affected based on an occupation assigned to the corresponding one or more other members.

In yet another embodiment of the non-transitory, computer-readable medium, the associated endorsement value of one or more of the other members may be assigned a first value when the one or more of the other members is assigned an occupation that corresponds to the specified occupation, the associated endorsement value of one or more of the other members may be assigned a second value when the one or more of the other members is assigned an occupation that does not correspond to the specified occupation, and the first value may be greater than the second value.

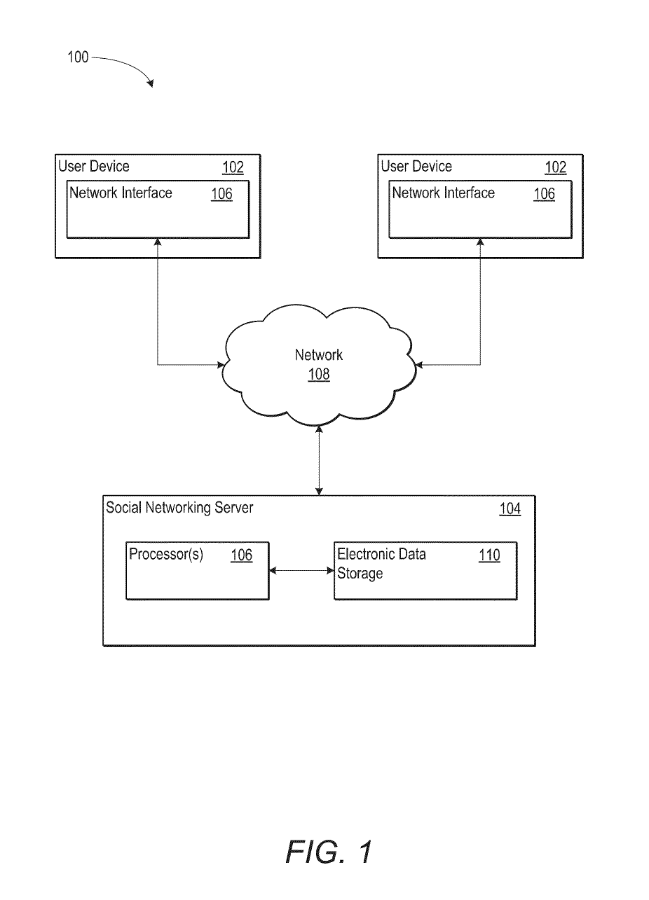

FIG. 1 is a block diagram of a system 100 in accordance with an example embodiment, including user devices 102 and a social networking server 104. In an embodiment, a particular type of social networking server may be referred to as a business network server. User devices 102 may be a personal computer, netbook, electronic notebook, smartphone, or any electronic device known in the art that is configured to display web pages. The user devices 102 may include a network interface 106 that is communicatively coupled to a network 108, such as the Internet.

The social networking server 104 may be communicatively coupled to the network 108. The server 104 may be an individual server or a cluster of servers, and may be configured to perform activities related to serving the social network, such as storing social network information, processing social network information according to scripts and software applications, transmitting information to present social network information to users of the social network, and receive information from users of the social network. The server 104 may include one or more electronic data storage devices 110, such as a hard drive, optical drive, magnetic tape drive, or other such non-transitory, computer-readable media, and may further include one or more processors 112.

The one or more processors 112 may be any type of commercially available processors, such as processors available from the Intel Corporation, Advanced Micro Devices, Texas Instruments, or other such processors. Furthermore, the one or more processors 112 may be of any combination of processors, such as processors arranged to perform distributed computing via the server 104.

The social networking server 104 may store information in the electronic data storage device 110 related to users and/or members of the social network, such as in the form of user characteristics corresponding to individual users of the social network. For instance, for an individual user, the user's characteristics may include one or more profile data points, including, for instance, name, age, gender, profession, prior work history or experience, educational achievement, location, citizenship status, leisure activities, likes and dislikes, and so forth. The user's characteristics may further include behavior or activities within and without the social network, as well as the user's social graph. In addition, a user and/or member may identify an association with an organization (e.g., a corporation, government entity, non-profit organization, etc.), and the social networking server 104 may be configured to group the user profile and/or member profile according to the associated organization.

For an organization, information about the organization may include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

The social networking server 104 may include one or more applications to determine a member's occupation based on information associated with the member's profile. In addition, the social networking server 104 may include one or more applications that determine and/or identify whether an employee of an organization has a specified occupation within the organization. For example, a user or another member of the social networking server 104 may desire to find employees of an organization who are salespersons, and the services available via the social networking server 104 may assist the user or another member to find those employees. Accordingly, at least in some examples, the social networking server 104 may include one or more applications that provide a searching service, an occupation identification service, and other such services that are customizable for use with multiple applications or services.

The one or more applications of the social networking server 104 may execute in real-time or as a background operation, such as offline or as part of a batch process. In some examples that incorporate relatively large amounts of data to be processed, the one or more applications may execute via a parallel or distributed computing platform.

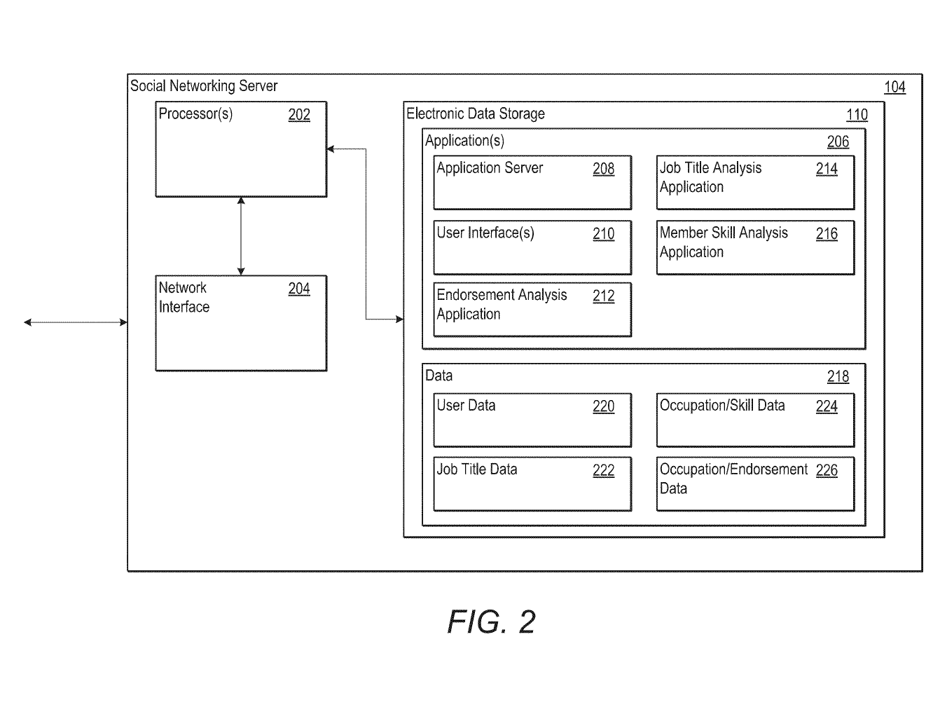

FIG. 2 is a block diagram illustrating various components of a social networking server 104 in accordance with an example embodiment. The social networking server 104 may be configured to determine whether a given organization has associated members with a particular occupation and may be configured to determine the occupation of a member given the member's profile data. In one embodiment, the social networking server 104 may include one or more processor(s) 202, one or more network interface(s) 204, one or more application(s) 206, and data 218 used by the one or more application(s) 206 stored in the electronic data storage 110.

As is understood by skilled artisans in the relevant computer and Internet-related arts, application shown in FIG. 2 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 2. However, a skilled artisan will readily recognize that various additional applications, engines, modules, etc., may be used with a social networking server 104 such as that illustrated in FIG. 2, to facilitate additional functionality that is not specifically described herein. Furthermore, the various applications depicted in FIG. 2 may reside on a single server computer, or may be distributed across several server computers in various arrangements.

The front end of the social networking server 104 may be provided by one or more user interface application(s) 210, which may receive requests from various client computing devices, and may communicate appropriate responses to the requesting client devices. For example, the user interface application(s) 210 may receive requests in the form of Hypertext Transport Protocol (HTTP) requests, or other web-based, application programming interface (API) requests. An application server 208 working in conjunction with the one or more user interface application(s) 210 may generate various user interfaces (e.g., web pages) with data retrieved from various data sources stored in the data 218. In some embodiments, individual application(s) (e.g., applications 212-216) may be used to implement the functionality associated with various services and features of the system 100. For instance, determining whether a member has a given occupation based on a job title found in the member's profile may be performed by a job title analysis application 214. As another example, determining whether a member has a given occupation based on skills the member has listed in his or her profile may be performed by a member skill analysis application 216. Similarly, the endorsement analysis application 212 may determine a member's occupation (or the probability the member has a given occupation) based on one or more endorsements for one or more skills associated with the member's profile.

The social networking server 104 may also include data 218, which may include one or more databases or other data stores that support the functionalities of the applications 208-216. In particular, data 218 may include user data 220, job title data 222, occupation/skill data 224, and/or occupation/endorsement data 226. While shown as being housed in the same box as application(s) 206, it should be understood that data 218 may be housed in another location or across locations (e.g., in a distributed computing environment).

User data 220 may include information about users and/or members of the social networking server 104. In various examples, when a person initially registers to become a user (and/or member) of the system 100, the person may be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. With particular regard to employment history, the user and/or member may be requested to provide information regarding his or her current employment (e.g., a job title or position) and skills that the user believes he or she possesses (e.g., “computer programming,” “investigative reporting,” “business development,” etc.).

User data 220 may also include endorsements of the skills that the user and/or member has identified as possessing. An endorsement may be an affirmation from another member that the user does, indeed, possess a given skill. Endorsements for a given skill may also be used to indicate whether other members have relevant experience with the user and the given skill. For example, where a user has listed “investigative journalism” as a skill, and that skill has 10 endorsements, those 10 endorsements may indicate that 10 other members have experience with the user and his or her “investigative journalism” skill. In this manner, the endorsements and skills listed in a user's and/or member's profile may provide a more complete picture of his or her experiences and the skillsets that the user and/or member may possess.

The social networking server 104 may also include data that facilitates determining whether a user and/or member has a given occupation based on a job title associated with the user's and/or member's profile. In this regard, job title data 222 may include data that associates one or more job titles with one or more occupations. For example, the job title data 222 may associate the job titles of “Salesperson,” “Vice-President of Marketing,” “Director of Online Consumer Products,” and other such titles with the occupation of “seller” and/or “buyer.” Thus, the job title data 222 may be used to help identify the occupation of a user and/or member depending on the job title listed in the profile for the user and/or member. In an additional or alternative embodiment, the job title data 222 may include probabilities and/or confidences such that a given job title is associated with a probability and/or degree of confidence that the associated user and/or member has a given occupation. This may include multiple probabilities being associated with multiple occupations. For example, the job title of “Vice-President of Marketing” may be associated with a first probability for a first occupation (e.g., 90% that the occupation is “salesperson”) and a second probability for a second occupation (e.g., 10% that the occupation is “director”). Thus, a single job title may be associated with multiple occupations, including probabilities that the job title indicates a particular occupation.

The social networking server 104 may further include data that facilitates determining whether a user and/or member has a given occupation based on the skills associated with the user's and/or member's profile. In this regard, occupation/skill data 224 may include data that associates one or more skills with one or more occupations. For example, the occupation/skill data 224 may associate the skill of “accounting” with “seller,” “buyer,” “accountant,” and other such occupations. Furthermore, the associations between skills and occupations may be a many-to-many association (i.e., a given skill may be associated with multiple occupations and a given occupation may be associated with multiple skills). Thus, the occupation/skill data 224 may be used to help identify the occupation of a user and/or member depending on the various skills listed in the profile for the user and/or member. In an additional or alternative embodiment, the occupation/skill data 224 may include probabilities and/or confidences such that a given skill is associated with a probability and/or degree of confidence that the associated user and/or member has a given occupation. This may include multiple probabilities being associated with multiple occupations (i.e., many-to-many associations).

Moreover, the possible occupations associated with the identified one or more skills may be associated with a numerical value (e.g., a probability, a percentage, a real number, etc.). For example, the skills of “accounting,” “relationship management,” and “inventory,” may yield a 95% probability that the user and/or member has a “seller” or “buyer” occupation. In addition, combinations of skills may increase or decrease the probability that a given set of skills is associated with one or more occupations. For example, the skills of “accounting,” “relationship management,” and “inventory,” may increase the probability that the user and/or member has a “seller” or “buyer” occupation, whereas the skills of “accounting,” “federal taxes,” and “bookkeeping,” may decrease the probability that the user and/or member has a “seller” or “buyer occupation,” but may increase the probability that the user and/or member has an “accountant” occupation. In this manner, the skills the user and/or member has identified as possessing may be used by the social networking server 104 to determine one or more possible occupations assignable to the user and/or member.

The social networking server 104 may also include data that facilitates determining whether a user and/or member has a given occupation based on the endorsements a user and/or member receives for one or more skills. In this regard, occupation/endorsement data 226 may include data that affects the probabilities and/or values determined using the occupation/skill data 224. More particularly, skills that receive more endorsements may increase the value or importance of a given skill when that skill is used to determine an occupation of the user and/or member or a probability that the user and/or member has a given occupation. For example, where the skill “accounting” has received fifteen endorsements and the skill “inventory” has received five endorsements, the value assigned to “accounting” may be greater than the value assigned to “inventory.”

Moreover, the occupations assigned to endorsers may affect the value of a given skill in determining the probability that the user and/or member has a given occupation. More particularly, occupations assigned to endorsers that are more relevant to a given occupation may be given more weight than occupations assigned to endorsers that are less relevant to the given occupation. Relevancy of an occupation may be predetermined or preprogrammed within the social networking server 104.

As an example, suppose that a user and/or member receives fifteen endorsements for a skill of “bookkeeping” and ten endorsements for a skill of “inventory.” In this example, more value may be assigned to the “bookkeeping” skill than to the “inventory” in determining the user's and/or member's occupation because the user and/or member has received more endorsements for the “bookkeeping” skill. The social networking server 104 may thus initially determine that the user and/or member is likely in a “sales” occupation. Further suppose, however, that the endorsers of the “bookkeeping” skill are assigned an “accountant” occupation and that the endorsers of the “inventory” skill are assigned a “finance” occupation. The social networking server 104 may then determine that the user and/or member is more likely to have an “accountant” occupation rather than the “sales” occupation because the occupations of the endorsers are less relevant to “sales” but more relevant to “accounting.” In this manner, not only do the number of endorsements affect the probability that a user and/or member has a given occupation, but the occupations of the endorsers may further affect the value of that probability.

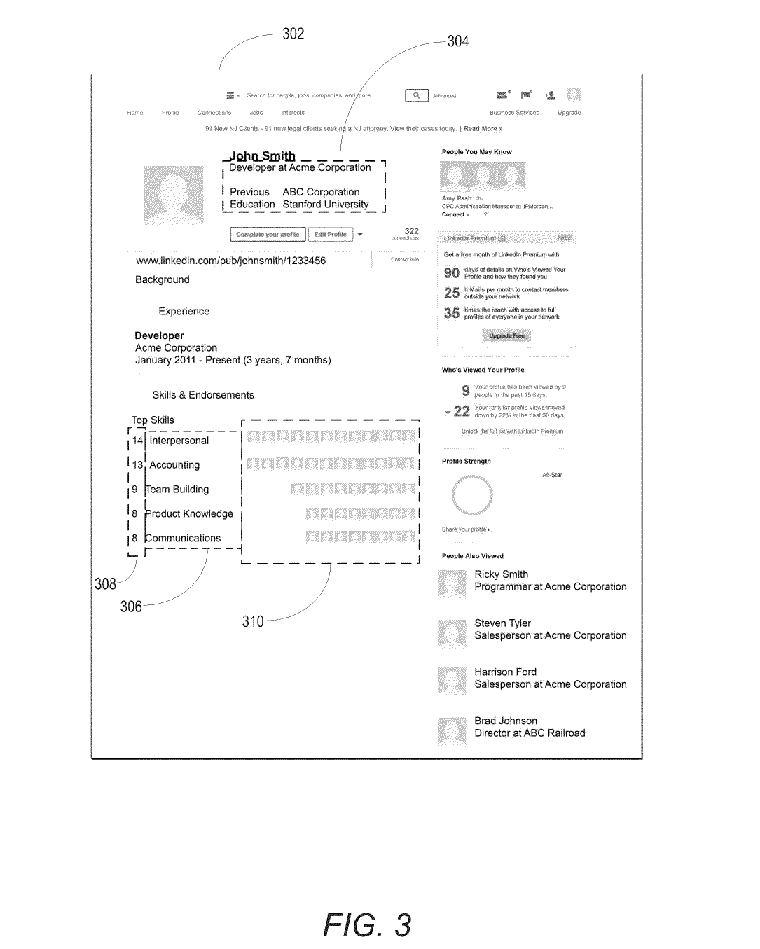

FIG. 3 illustrates a first member profile 302, in accordance with an example embodiment, having information that may be processed by the social networking server 104 to determine a member's occupation. In one embodiment, the social networking server 104 may extract information from one or more portions of the member profile 302 including, but not limited to, a headline portion 304, a skills portion 306, an endorsement value portion 308, and an endorser portion 310.

While FIG. 3 illustrates that the social networking server 104 may extract information from the various portions 304-310, one of ordinary skill in the art will recognize that the social networking server 104 may extract information from other portions (e.g., an employment history portion) as well.

The headline portion 304 may include a brief summary of the member's employment history. In one embodiment, the headline portion 304 may include such information as the member's current employer, the member's job title at the current employer, and the member's previous employer. The member's job title may briefly describe the member's position at the current employer, but it may also describe a department or division to which the member is assigned within the current employer. The social networking server 104 may be configured to extract information from the headline portion 304, such as the member's job title and the member's current employer. As discussed below, the social networking server 104 may use the information from the headline portion 304 to group member profiles according to the employer (current and/or previous) listed in the headline portion 104.

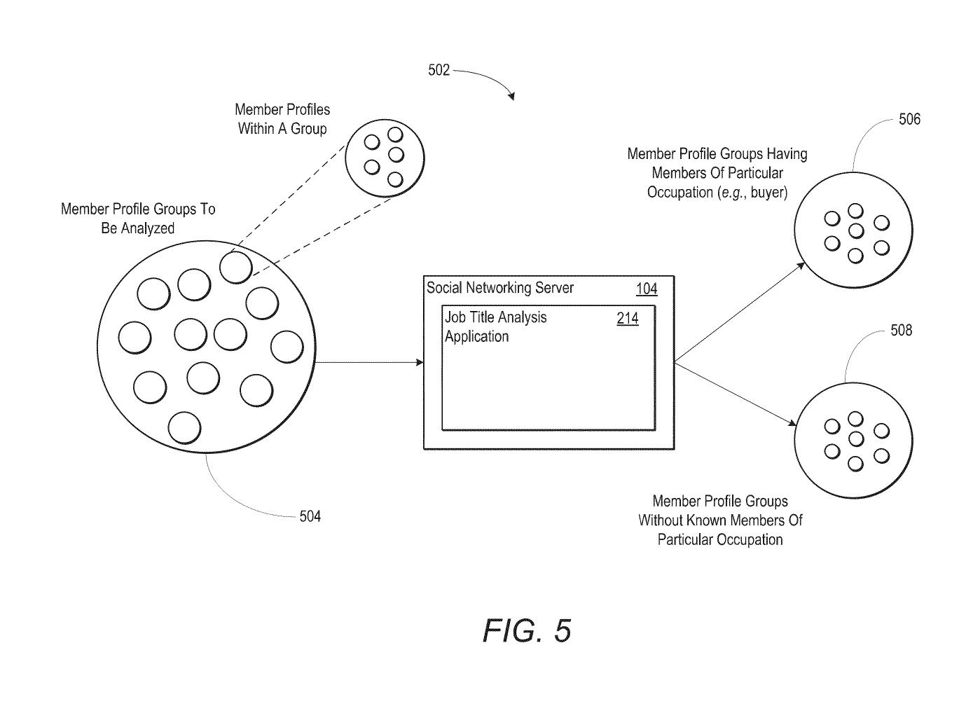

The skills portion 306 may list one or more skills that the user and/or member has identified as possessing. In one embodiment, the user and/or member may select one or more skills from a predetermined list of skills. In other embodiment, the user and/or member may provide a skill to the social networking server 104 to be displayed on the user's and/or member's profile. The one or more skills displayed in the skills portion 306 may be stored by the social networking server 104, such as in the user data 220. As discussed below and with reference to FIG. 2 in conjunction with FIG. 5, the social networking server 104 may invoke the member skill analysis application 216 to obtain the skills from the skills portion 306, such as by retrieving the skills from the user data 220, and then referencing the occupation/skill data 224 with the retrieved skills to determine an occupation or one or more occupation probabilities for the user and/or member.

One or more members of the social networking server 104 may endorse one or more skills listed in the skills portion 306. As shown in FIG. 3, the endorsements of the skills may include an endorsement value portion 308 and an endorser portion 310. The endorsement value portion 308 may indicate or display endorsement values assigned to one or more skills. An endorsement value may indicate the number of users and/or members that have endorsed a given skill. For example, the “interpersonal” skill is shown as having an endorsement value of “14.” The endorser portion 310 may display and/or list the users and/or members that have endorsement a given skill. For example, the endorser portion 310 may list or display the users and/or members that have endorsed the “interpersonal” skill. The endorsement values and/or lists of endorsers may be stored by the social network server 104, such as in the user data 220.

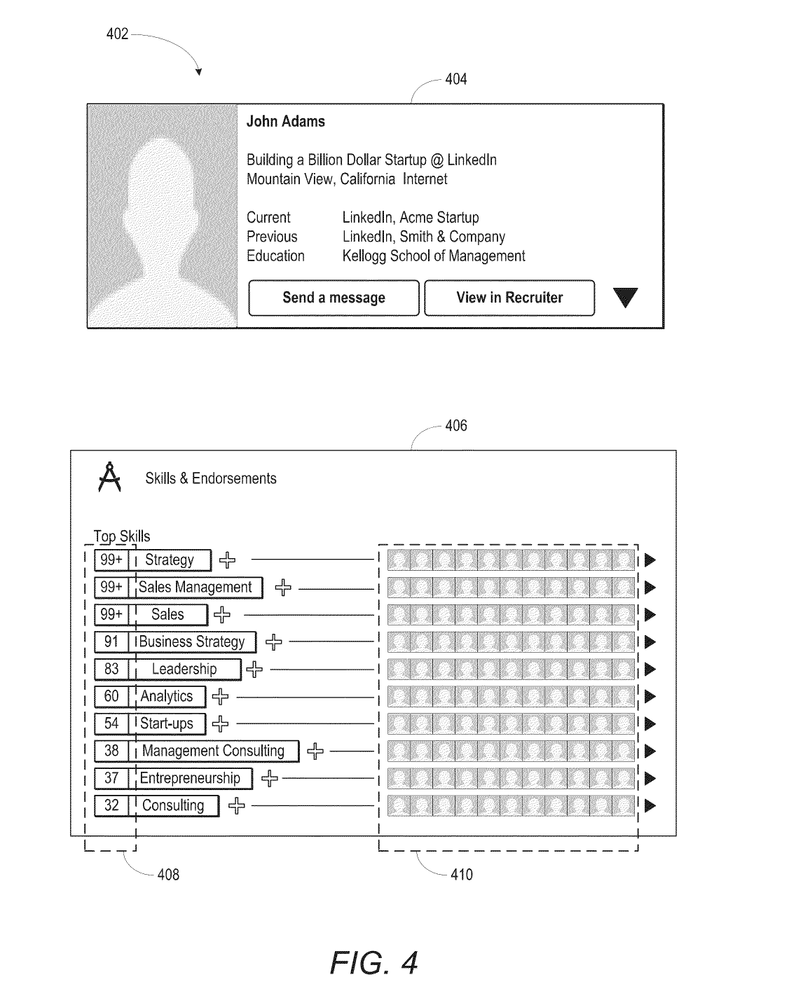

FIG. 4 illustrates a second member profile 402, in accordance with an example embodiment, having information that may be processed by the social networking server of FIG. 1 to determine a member's occupation. The second member profile 402 may also include a headline portion 404 and a skills portion 406. Furthermore, the skills portion 406 may include an endorsement value portion 408 and an endorser portion 410.

As shown in FIG. 4, the headline portion 404 of the second member profile 402 may not indicate that the member associated with the member profile 402 is in a sales occupation. Furthermore, it is possible that the member associated with the member profile 402 does not consider himself or herself to be in a sales occupation. However, the social networking server 104 may be configured to extract information from the member profile 402, such as one or more endorsement values from the endorsement value portion 408 and/or information about one or more endorsers from the endorser portion 410, to determine whether the member associated with the member profile 402 is in a sales occupation. As discussed below, one or more of the skills from the skills portion 406, one or more values from the endorsement value portion 408, and/or information about one or more endorsers from the endorser portion 410 may serve as a metric in determining whether the member associated with the member profile 402 is likely to be in a sales occupation.

As discussed below, and with reference to FIG. 2 in conjunction with FIG. 5, the social networking server 104 may invoke one or more applications to retrieve and process the endorsement values and/or endorsers. In particular, the social networking server 104 may invoke the endorsement analysis application 212 to process the endorsement values endorsement value portion 308 and the lists of endorsers shown in the endorser portion 310. As previously discussed, the endorsement values and the endorsers may affect the occupation probability determination for the user and/or member associated with the profile 302.

The foregoing applications and data may be useful in helping a user target members of an organization having a particular occupation or for determining whether an organization has members of a particular occupation. For example, a user selling a product (or a user wanting to buy a product) may desire to know whether an organization has an employee having a buyer occupation or seller occupation. In that regard, the system may collect and organize one or more member profiles into member profile groups based on an organization (e.g., an employer) associated with a member profile. For example, there may be a first group of member profiles associated with a first employer, a second group of member profiles associated with a second employer, and so forth.

FIG. 5 illustrates a process 502, in accordance with an example embodiment, of the social networking server 104 of FIG. 1 segmenting member profile groups according to aspects of the disclosure. In one embodiment, the social networking server 104 may determine groupings 504 of the member profiles associated with the social networking server 504. The grouping may be based on a member's employer. In this regard, each of the groups shown in the groupings 504 may represent a particular employer. Other groupings are also possible, such as groupings based on affiliations, professional associations, and other such organizations. The social networking server 104 may determine to which group a given member profile belongs by extracting and/or analyzing one or more portions of the given member profile, such as the headline portion 304.

Once organized into groups, the social networking server 104 may invoke the job title analysis application 214 to determine whether one or more member profiles are labeled with a particular job title. More particularly, the job title analysis application 214 may draw on job title data 222, which, as discussed previously, may associate one or more job titles with one or more occupations. In one embodiment, the job title analysis application 214 may analyze and/or compare a job title found in a portion of the member profile 302, such as the headline portion 304, with the job titles stored in the job title data 222. In this manner, the social networking server 104 may perform an initial assignment of a given occupation to member profiles based on the results of the job title analysis application 214.

In one embodiment, the social networking server 104 may employ an occupation threshold value which the social networking server 104 may use to determine whether a given group of member profiles should have further processing performed. The occupation threshold value may further vary depending on the particular occupation. In other words, the occupation threshold value may specify whether a sufficient number of members having a given occupation were found for a given grouping. As shown in FIG. 5, the social networking server 104 may classify the groupings 504 into one of two groups, a first grouping 506 where a sufficient number of members associated with a given organization were identified as having a given occupation and a second grouping 508 where a sufficient number of members associated with a given organization were not identified as having the given occupation.

As a more concrete example, suppose that the social networking server 104 is attempting to identify whether one or more employers have associated members with a “buyer” occupation. The social networking server 104 may first determine whether one or more employers have members with job titles corresponding to the “buyer” occupation. The social networking server 104 may further have an occupation threshold value for the “buyer” occupation of “10%”, meaning, that 10% of the employer's associated members should have the “buyer” occupation to for the employer to be placed into the first grouping 506. Where the social networking server 104 determines that the employer does not have a number of associated members having the given occupation that meets or exceeds the occupation threshold, the employer (i.e., the member profile grouping) may be placed into the second grouping 408 for further analysis.

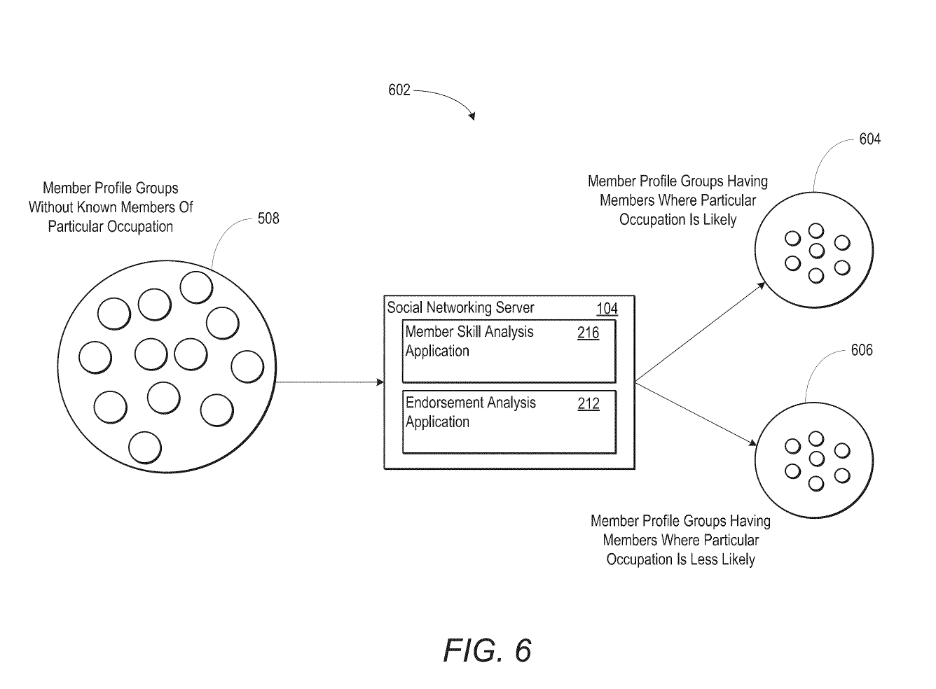

FIG. 6 illustrates a process 502, in accordance with an example embodiment, of the social networking server 104 further segmenting member profile groups 508 based on skills and endorsements. As shown in FIG. 6, the social networking server 104 may invoke the member skill analysis application 216 and the endorsement analysis application 212 on the member profiles of the profile groups 508 to determine the probability of whether a given member profile indicates whether the corresponding member has a given occupation. In this regard, the member skill analysis application 216 may analyze the skills associated with a given member profile to determine the probability that the given member profile should be associated with a given occupation, and the endorsement analysis application 212 may analyze the endorsements and/or endorsers for the skills analyzed by the member skill analysis application 216. As discussed above, the member skill analysis application 216 may yield an initial probability that the member of the analyzed member profile has a given occupation, which may then be adjusted (i.e., increased or decreased) based on the analysis of the endorsements and endorsers of the analyzed skills.

As with process 502, the social networking server 104 may maintain an occupation probability threshold value that it uses to indicate whether a member has a given occupation. The social networking server 104 may compare the occupation probability threshold value with one or more determined occupation probabilities (i.e., probabilities indicating whether a given member has a given occupation). When the occupation probability threshold value is met or exceeded, the social networking server 104 may assign the member profile to a third grouping 604, which may include profiles where the corresponding member is likely to have a given occupation. Otherwise, the social networking server 104 may assign the member profile to a fourth grouping 606, which may include profiles where the corresponding member is not likely to have a given occupation. When the social networking server 104 completes the analysis of the member profile groups 508, the social networking server 104 may provide a list of members associated with a particular organization having a given occupation.

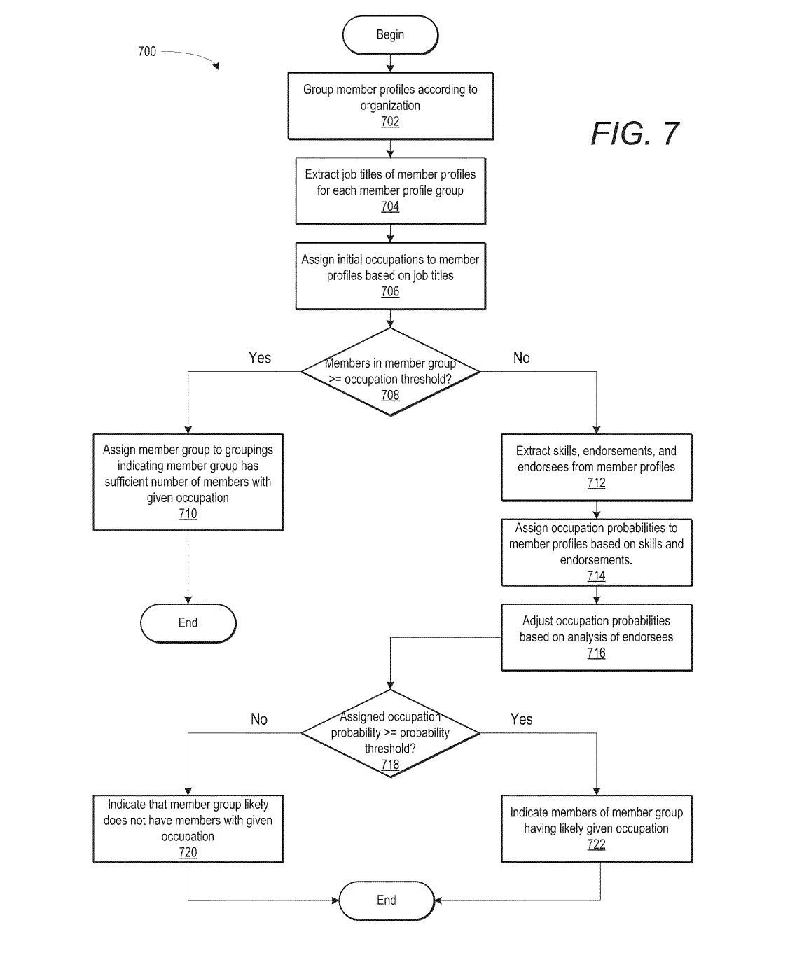

FIG. 7 illustrates a method 700, in accordance with an example embodiment, for determining a member's occupation. The method 700 may be implemented on the social networking server 104 and, accordingly, is merely described by way of reference thereto. With reference to FIG. 2, the social networking server 104 may initially group one or more user profiles and/or member profiles based on an organization (e.g., the current employer listed on the user's and/or member's profile) (Operation 702). The social networking server 104 may then invoke the job title analysis application 214 to extract and/or retrieve job titles for each of the member profiles in the various assigned groups (Operation 704).

The job title analysis application 214 may then assign initial occupations to the member profiles based on the job title, such as by comparing the retrieved job title with one or more job titles stored in the job title data 222 (Operation 706). For each member group, the social networking server 104 may then compare the percentage and/or number of member profiles having a given occupation with an occupation threshold value (Operation 708). Where the percentage and/or number of member profiles for a given member group exceeds the occupation threshold, the member group may be assigned to a group of member profiles where the member groups have a sufficient number of members with the given occupation (Operation 710).

However, where the number of member profiles is less than the occupation threshold value, the social networking server 104 may perform additional analysis and processing on the deficient member groups. In particular, the social networking server 104 may invoke the endorsement analysis application 212 and/or the member skill analysis application 216 to extract (Operation 712) and analyze the skills and endorsements for a given member profile. Based on the analysis of the skills and endorsement values, the social networking server 104 may assign one or more probabilities to the member profile, the one or more probabilities indicating the probability the member associated with the member profile has a given occupation (Operation 714). The probabilities assigned by the social networking server 104 may further be adjusted based on the endorsers of the various skills (Operation 716).

The social networking server 104 may then determine whether the determined probabilities for a given member profile exceed an occupation probability threshold value for a given occupation (Operation 718). Where this is answered in the affirmative, the member profile may be assigned to a group of member profiles indicating that the member profile is likely to have the given occupation (Operation 722). Alternatively, where this decision is answered negatively, the member profile may be assigned to a group of member profiles indicating that the member profile is not likely to have the given occupation (Operation 720). The social networking server 104 may then display a list of members for a given organization having the given occupation and/or a list of organizations where the social networking server 104 could not determine or locate a member having the given occupation.

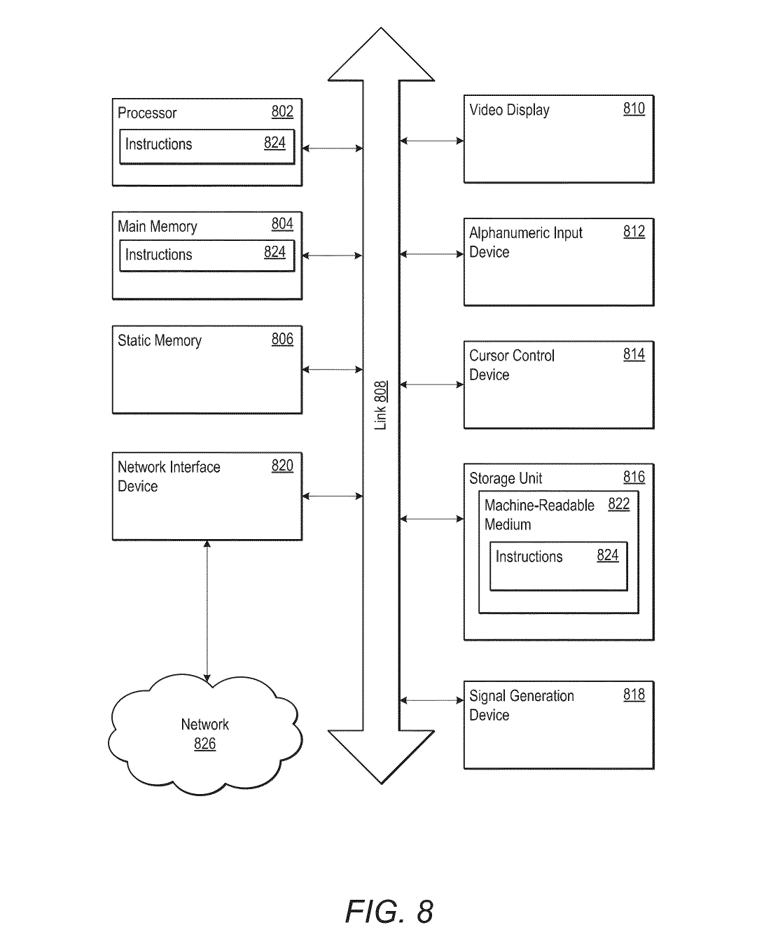

FIG. 8 is a block diagram illustrating components of a machine 800, in accordance with an example embodiment, configured to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative examples, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method for determining an occupation of a person employed at a company, the method comprising:
identifying, with one or more processors, a second plurality of company profiles from a first plurality of company profiles based on an occupation threshold, the occupation threshold corresponding to a predetermined amount of member profiles where a member profile has been identified as having a specified occupation;
identifying, with the one or more processors, a third plurality of company profiles from the first plurality of company profiles based on the identified second plurality of company profiles, the third plurality of company profiles having at least one company profile associated with a member profile where the specified occupation is not assigned; and
for at least one company profile within the third plurality of company profiles, assigning, with the one or more processors, the specified occupation to an associated member profile based on one or more attributes selected by a member corresponding to the member profile; and
assigning the member profile to a plurality of member profiles having the specified occupation.

2. The method of claim 1, wherein the one or more attributes comprise at least one skill that the member has identified as possessing, the at least one skill having been selected from a plurality of selectable skills.

3. The method of claim 1, wherein at least one attribute of the one or more attributes has an endorsement value, the endorsement value indicating whether one or more other members have endorsed the member as having the at least one attribute.

4. The method of claim 1, wherein:
the one or more attributes comprise at least one skill that the member has selected from a plurality of skills;
the at least one skill has an endorsement value, the endorsement value indicating whether one or more other members have endorsed the member for the at least one skill; and
assigning the specified occupation to the associated member profile comprises evaluating the endorsement value of the at least one skill

5. The method of claim 4, wherein an occupation assigned to the one or more other members which affects the endorsement value of the at least one skill.

6. The method of claim 4, wherein each of the one or more other members have an associated endorsement value, and the associated endorsement value is affected based on an occupation assigned to the corresponding one or more other members.

7. The method of claim 6, wherein:
the associated endorsement value of one or more of the other members is assigned a first value when the one or more of the other members is assigned an occupation that corresponds to the specified occupation;
the associated endorsement value of one or more of the other members is assigned a second value when the one or more of the other members is assigned an occupation that does not correspond to the specified occupation; and
the first value is greater than the second value.

8. The method of claim 1, wherein a plurality of attributes are mapped to a plurality of occupations; and the method further comprises:
selecting the specified occupation from the plurality of occupations based on a comparison of the one or more attributes selected by the member.

9. A system for determining
a non-transitory, computer-readable medium that stores computer-executable instructions; and
one or more processors in communication with the non-transitory, computer-readable medium that, when the computer-executable instructions are executed, are configured to:
analyze a first plurality of member profiles of a social network to determine whether any of the member profiles have been identified a having a specified occupation;
assign at least one member profile from the first plurality of member profiles to a second plurality of member profiles when the at least one member profile has not been identified as having the specified occupation;
determine whether to associate the specified occupation with the at least one member profile of the second plurality of member profiles based on one or more attributes associated with the at least one member profile, the one or more attributes having been selected by a member corresponding to the at least one member profile; and
associate the specified occupation with the at least one member profile based on an affirmative determination.

10. The system of claim 9, wherein the one or more attributes comprise at least one skill that the member has identified as possessing, the at least one skill having been selected from a plurality of selectable skills.

11. The system of claim 9, wherein at least one attribute of the one or more attributes has an endorsement value, the endorsement value indicating whether one or more other members have endorsed the member as having the at least one attribute.

12. The system of claim 9, wherein:
the one or more attributes comprise at least one skill that the member has selected from a plurality of skills;
the at least one skill has an endorsement value, the endorsement value indicating whether one or more other members have endorsed the member for the at least one skill; and
the one or more processors are further configured to determine whether to associate the specified occupation with the at least one member profile of the second plurality of member profiles by evaluating the endorsement value of the at least one skill.

13. The system of claim 12, wherein an occupation assigned to the one or more other members which affects the endorsement value of the at least one skill.

14. The system of claim 12, wherein each of the one or more other members have an associated endorsement value, and the associated endorsement value is affected based on an occupation assigned to the corresponding one or more other members.

15. The system of claim 14, wherein:
the associated endorsement value of one or more of the other members is assigned a first value when the one or more of the other members is assigned an occupation that corresponds to the specified occupation;
the associated endorsement value of one or more of the other members is assigned a second value when the one or more of the other members is assigned an occupation that does not correspond to the specified occupation; and
the first value is greater than the second value.

16. The system of claim 9, wherein a plurality of attributes are mapped to a plurality of occupations; and
the one or more processors are further configured to select the specified occupation from the plurality of occupations based on a comparison of the one or more attributes selected by the member.

17. A non-transitory, computer-readable medium having computer-executable instructions stored thereon that, when executed by one or more processors, cause the one or more processors to perform a method, the method comprising:
identifying, with one or more processors, a second plurality of company profiles from a first plurality of company profiles based on an occupation threshold, the occupation threshold corresponding to a predetermined amount of member profiles where a member profile has been identified as having a specified occupation;
identifying, with the one or more processors, a third plurality of company profiles from the first plurality of company profiles based on the identified second plurality of company profiles, the third plurality of company profiles having at least one company profile associated with a member profile where the specified occupation is not assigned; and
for at least one company profile within the third plurality of company profiles, assigning, with the one or more processors, the specified occupation to an associated member profile based on one or more attributes selected by a member corresponding to the member profile; and
assigning the member profile to a plurality of member profiles having the specified occupation.

18. The non-transitory, computer-readable medium of claim 17, wherein:
the one or more attributes comprise at least one skill that the member has selected from a plurality of skills;
the at least one skill has an endorsement value, the endorsement value indicating whether one or more other members have endorsed the member for the at least one skill; and
assigning the specified occupation to the associated member profile comprises evaluating the endorsement value of the at least one skill

19. The non-transitory, computer-readable medium of claim 18, wherein each of the one or more other members have an associated endorsement value, and the associated endorsement value is affected based on an occupation assigned to the corresponding one or more other members.

20. The non-transitory, computer-readable medium of claim 19, wherein:
the associated endorsement value of one or more of the other members is assigned a first value when the one or more of the other members is assigned an occupation that corresponds to the specified occupation;
the associated endorsement value of one or more of the other members is assigned a second value when the one or more of the other members is assigned an occupation that does not correspond to the specified occupation; and
the first value is greater than the second value.
